(19) United States
(12) Patent Application Publication
(10) Pub. No.: US 2002/0005244 A1
(43) Pub. Date: Jan. 17, 2002

(54) Disposable liner

(76) Inventors: Reuven Y. Rosenberg, Lawrence, NY (US); Gabriel Kahana, Monsey, NY (US); Awad Sike, St. Prospeck Park, NJ (US)

Correspondence Address: CANTOR COLBURN, LLP, 55 GRIFFIN ROAD SOUTH, BLOOMFIELD, CT, 06002

(21) Appl. No.: 09/802,206

(22) Filed: Mar. 8, 2001

Related U.S. Application Data
(62) Division of application No. 09/302,107, filed on Apr. 29, 1999, now abandoned.

(51) Int. Cl. B31F 1/00

(52) U.S. Cl. 156/226

(57) ABSTRACT

The present invention is directed to a plastic liner for use in containers which are typically used in the meat packing industry to hold the meat portion of an animal carcass after it has been subjected to a slaughtering process. The liner is designed so that its bottom seal is able to withstand the stress placed thereupon by accumulation of blood and other liquids from the meat. In other words, the bottom seal is a leak-proof seal due to it having a substantially uniform thickness.

### CROSS REFERENCE TO RELATED APPLICATIONS

The present application is a divisional application of co-pending application No. 09/302,107, filed on Apr. 29, 1999, the entire disclosure of which are specifically incorporated by reference herein.

### BACKGROUND OF INVENTION

1. Technical Field

The present invention relates in general to a package article and more specifically to a disposable liner made of plastic or the like material, of the type which is suitable for use in a meat packaging facility for holding meat and the like.

2. Background

As is known in the meat packaging industry, animal carcasses are transported to a meat processing and packaging plant for processing. At this location, the carcasses are processed so that the desired and valuable meat of the animal is separated away from other bodily components, such as bone, organs, and bodily fluids to name a few. This separation process generally involves the use of cutting devices which act to cut the meat away from the carcass so that the meat can be transported for further processing. Further processing of the meat may involve making additional cuts into the meat, cleaning the meat, and packaging the meat for further transportation to additional facilities which market the product to consumers.

Because the desired meat portion of the animal carcass only comprises a portion of the carcass itself, the meat must be stripped from the carcass and placed in containers for transportation and further processing. More specifically, the meat portion of the carcass is stored in containers separate from the containers which hold the animal waste products which include bodily fluids such as blood and fluid waste products such as urine. The meat portion itself also contains bodily fluids, such as blood, and typically, the meat is placed in large cardboard containers which are lined with a plastic liner. The plastic liner is designed to catch and hold the meat so that the meat may be isolated, packaged and finally transported for disposal. One notably disadvantage of conventional plastic liners used in the cardboard containers is that the blood from the meat tended to accumulate and settle on the bottom of the cardboard container resulting in a great amount of stress being applied to the bottom seal of the liner. As the blood accumulates, it finds the weakest point of the plastic liner and leaks out causing a major mess. The reason for the leakage problem is that the conventional liners used in the meat packing have an inherently weak bottom seal. Thus, the weight and volume of the meat itself and the associated blood places a stress upon the seal and it gives way and leakage occurs.

In order to overcome this problem, the meat packing industry has tried to use double liners in the cardboard containers. These efforts have proved largely unsuccessful and add unnecessary cost because of the two fold increase in liners per a given cardboard container. Thus, there is a need for a plastic liner for use in cardboard containers used in the meat packing industry for holding meat and its blood after the animal has been slaughtered.

### SUMMARY OF INVENTION

The present invention comprises a plastic liner for use in containers which are used in the meat packing industry to hold meat after the animal has been slaughtered. A plastic liner blank is provided and a pair of side gussets are formed therein. The pair of side gussets comprise vertical gussets which travel the length of the plastic liner blank. In accordance with the present invention, the depth of the each gusset is such that there is only a minimal distance between the gussets after they are formed in the plastic liner blank. Preferably, the distance between the gussets is about 1-2 inches and more preferably about 1 inch. After forming the side gussets, the plastic liner blank is folded in half along a center line resulting in one of the side gussets being folded onto the other side gusset. After folding the plastic liner blank in this manner, the plastic liner blank is generally in the form of a rectangle and preferably the width of an individual side gusset substantially represents the width of the rectangle.

Individual plastic liners are formed from the plastic liner blank by introducing the plastic liner blank into a device which intermittently provides a seal at predetermined locations of the plastic liner blank. Preferably, the seal is formed by applying heat and pressure along a line which causes the layers of the plastic liner blank to bond to another. In addition, a perforated separation line is provided adjacent the seal and this permits individual plastic liners to be separated from one another by grasping one end of the plastic liner and separating it from the rest along the perforated line.

The present invention presents a plastic liner designed to catch and hold animal meat so that the meat is easily transportable for further processing and/or packaging. More importantly, the present construction of the plastic liner offers a strong bottom seal which does not include an inherently weak bottom seal which is associated with prior art liners for use in the meat packing industry. The bottom seal is a leak-proof seal due to the seal having a substantially uniform thickness. Thus, the present invention eliminates the leakage of blood from the bottom seal and is more cost effective than current practices.

The above-described and other features and advantages of the present invention will be appreciated and understood by those skilled in the art from the following detailed description, drawings, and appended claims.

### BRIEF DESCRIPTION OF DRAWINGS

Referring now to the drawings wherein like elements are numbered alike in the several FIGURES:

FIG. 1 illustrates a conventional two sided gusseted article of the prior art;

FIGS. 2-3 show an assembly step for forming the two sided gusseted article of FIG. 1; and

FIGS. 4-7 show the progressive preferred assembly steps used in forming a plastic liner in accordance with the present invention.

### DETAILED DESCRIPTION

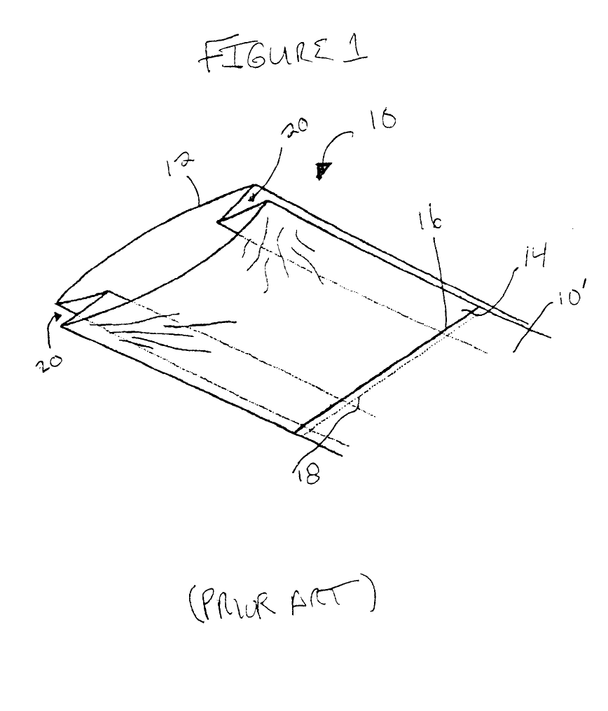

Referring to FIG. 1, in which a conventional plastic liner is generally indicated at 10. Plastic liner 10 has a first open end 12 and an opposite sealed second end 14. At second end 14, a seal 16 extends the width of plastic liner 10 and serves to close second end 14. Adjacent seal 16 is a perforated separation line 18 which permits plastic liner 10 to be easily removed from adjacent material in which a plurality of plastic liners 10 are formed. As is known in the art, upon separating plastic liner 10 along perforated separation line 18 at second end 14, the adjacent material is opened along perforated separation line 18 to form what is now an open end for an adjacent plastic liner 10′.

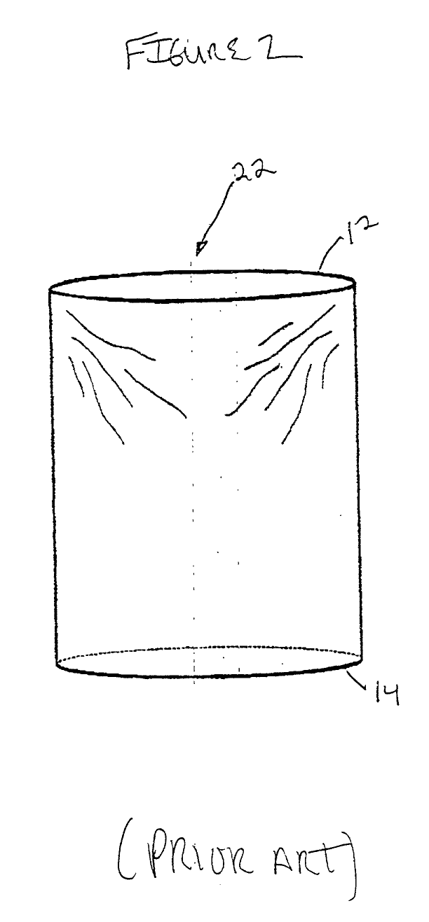

Turning now to FIGS. 1-3, plastic liner 10 includes a pair of side gussets 20. As shown in FIG. 2, plastic liner 10 is formed from a plastic liner blank 22. Plastic liner blank 22 also includes a central line 24 which marks the approximate center of plastic liner blank 22. When the pair of side gussets 20 are formed in plastic liner blank 22, inner edge lines 26 are created and partially define the pair of side gussets 20. Central line 24 and inner edge lines 26 are substantially parallel to one another. Inner edge lines 26 of gussets 20 are formed so that each of inner edge lines 26 does not extend closely to central line 24. In other words, there is a distance A between inner edge lines 26 of plastic liner blank 22 and a distance B between each of edge lines 26 and central line 24.

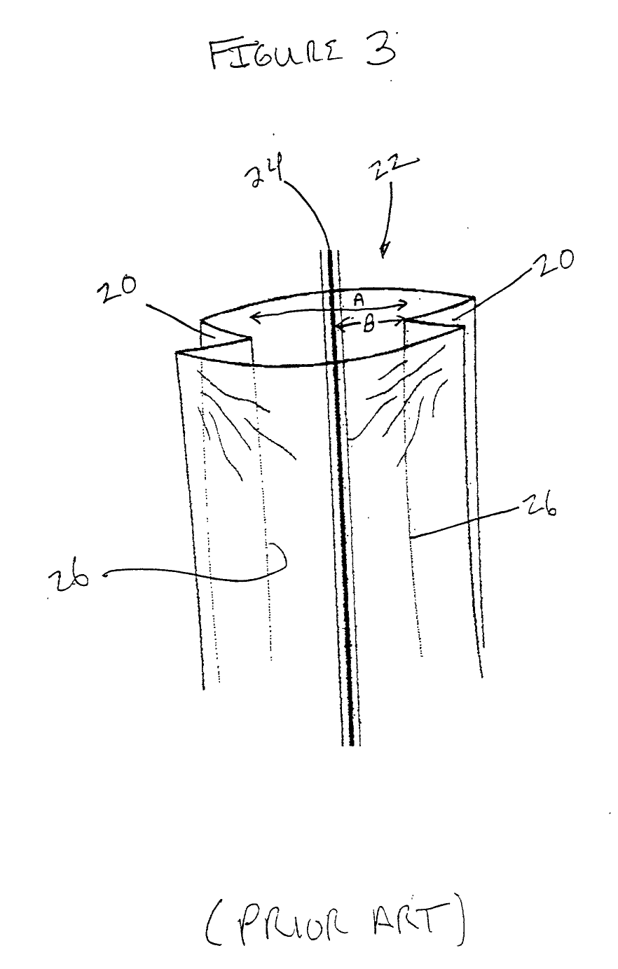

After forming the pair of side gussets 20, seal 16 is formed at second end 14 by conventional sealing techniques resulting in second end 14 being closed. Perforated separation line 18 is also formed in plastic liner blank 22 by conventional techniques. Plastic liner 10 suffers from the associated deficiency that when plastic liner 10 is sealed, the distance A shown in FIG. 3 comprises a double thickness seal due to the lack of any gussets 20 being located within this region. The outermost regions of plastic liner 10 include a quadruple thickness seal because of the presence of gussets 20. Consequently, seal 16 is not uniform because of this difference in thickness along the width of the material forming plastic liner 10. This results in an inherently weak seal 16 due to the non-uniform thickness of seal 16. At this inherently weak region, seal 16 has a tendency to leak.

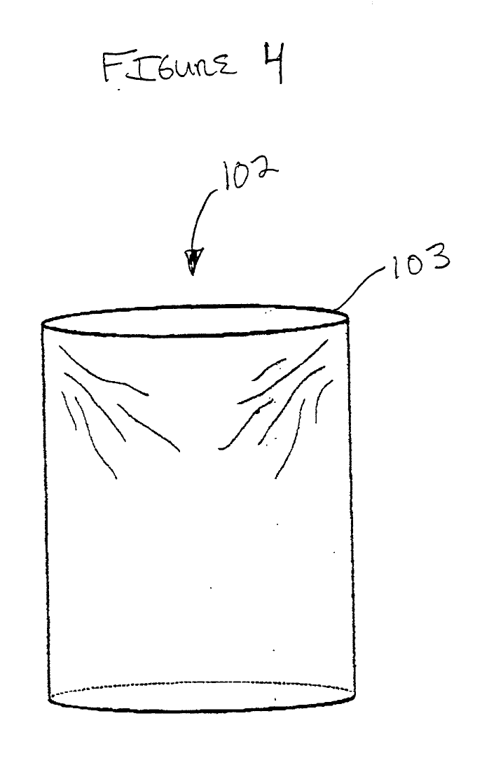

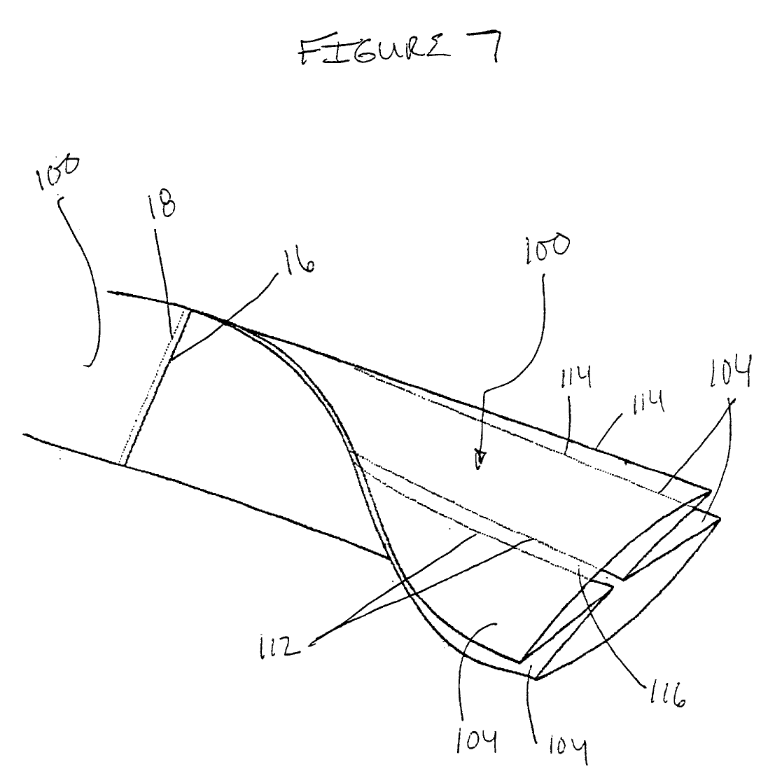

Referring now to FIGS. 4-7 which show the progressive preferred assembly steps used in forming a plastic liner in accordance with the present invention. As best shown in FIG. 7, an individual plastic liner of the present invention is generally indicated at 100. Plastic liner 100 comprises a liner for use in a receptacle, e.g. container, and is particularly intended for use as a liner for containers used in the meat packing industry to collect the meat portion of a carcass during a slaughtering process. In an exemplary and preferred embodiment, plastic liner 100 is formed of polyethylene and has a thickness of about 3 mil. It being understood that this is an exemplary material and exemplary thickness and it is within the scope of the present invention that other suitable materials may be used having varying thicknesses.

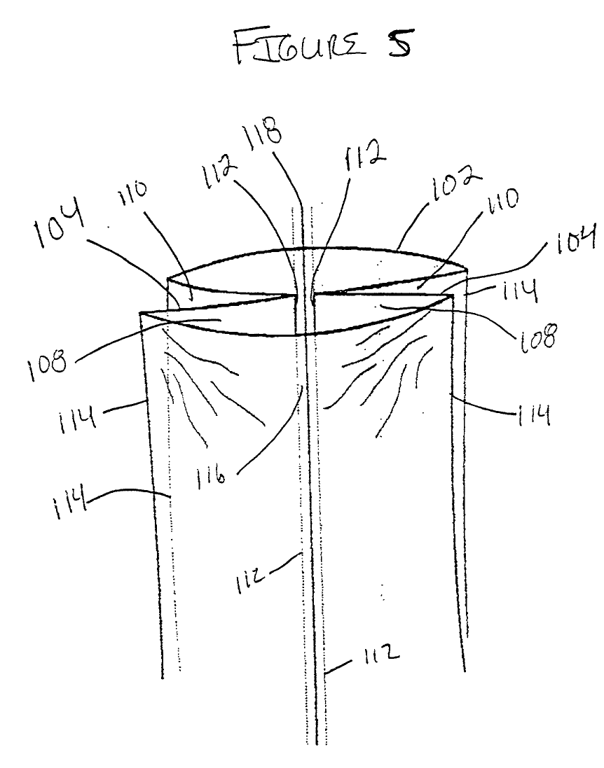

Now returning to FIGS. 4-7. FIG. 4 shows a plastic liner blank 102 in an initial form as a plastic film tube 103 having a diameter of about 98 inches. As shown in FIG. 5, a gusset 104 is provided on opposing sides of plastic film tube 102. Gusset 104 comprises a V-shaped tuck including a first surface 108 and a second surface 110 which generally face one another and converge at an inner edge line 112 to form gusset 104. When gussets 104 are formed in plastic liner blank 102, a pair of outer gusset edges 114 are formed which oppose one another and outer gusset edges 114 may be brought together to form the generally rectangular plastic liner blank 102 shown in FIG. 5. Outer gusset edges 114 form the open ended outer part of the V-shaped gusset 104. When gussets 104 are formed in plastic liner blank 102, plastic liner blank 102 no longer takes the form of tubular member 103 and may lie flush against a surface to form a generally rectangular plastic liner blank 102. Plastic liner blank 102 has a minimal central area 116 extending between gussets 104, wherein central area 116 is a non-gusseted region. It being understood that gussets 104 are vertical gussets which run the entire length of plastic liner blank 102. In this second position, shown in FIG. 5, the width of each gusset 104 is approximately 24 inches, thereby the width of the rectangular plastic liner blank 102 of FIG. 4 is about 49-50 inches (partially defined by 2 gussets at 24 inches). In this one exemplary embodiment, central area 116 is approximately 1 to 2 inches in width. Thus, the distance between gussets 104 is minimal and in an exemplary embodiment is about 1-2 inches.

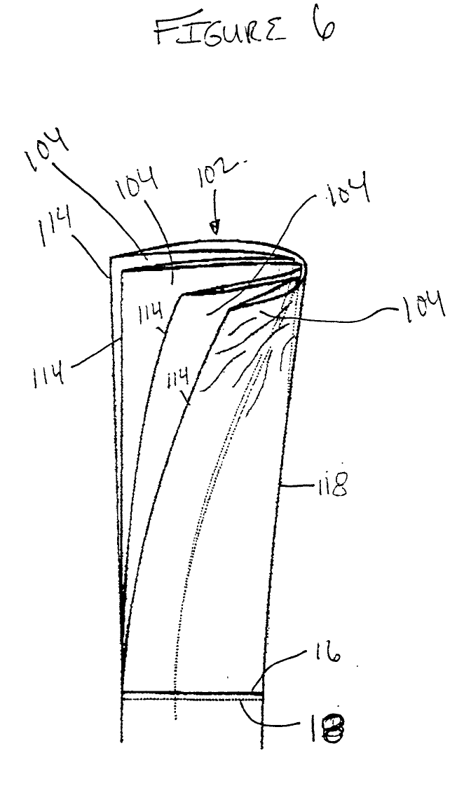

In FIG. 5, plastic liner blank 102 is folded along a generally central fold axis 118 of plastic liner blank 102 resulting in one of gussets 104 being folded over on top of the other of gussets 104. In this configuration, outer gusset edges 114 are generally stacked on one another to define one side edge of the folded plastic liner blank 102. The opposite side edge of the folded plastic liner blank 102 is defined by central fold line 118 in central area 116. As shown in FIG. 6, the plastic liner blank 102 generally is still in the form of a rectangle having a width which is 1/2 of the width of plastic liner blank 102 in FIG. 5 prior to the folding procedure shown in FIG. 6. In the exemplary embodiment, the width of folded plastic liner blank 102 is about 25 inches. Central region (not shown) has a width which sufficiently permits the folding of one gusset 104 over onto the other gusset 104. Consequently, the pair of side gussets 104 are formed so that the inner edge lines 112 of gussets 104 are substantially parallel and adjacent to central region 116 of plastic liner blank 102. When plastic liner blank 102 is folded along central fold line 118 so that one of gussets 104 is folded on top of the other of gussets 104, only a minor amount of the central region is visible because of it having a reduced and minimal width. Central fold line 118 defines one side edge of the individual plastic liners 100.

The folded plastic liner blank 102 is then subjected to a conventional bag machine which forms individual plastic liners 100 from plastic liner blank 102. In an exemplary embodiment, plastic liner blank 102 is about 196 inches long and individual plastic liners 100 are about 96 inches in length. It being understood that these lengths are merely exemplary in nature and plastic liner 102 may have a variety of lengths which permit individual plastic liners 100 having predetermined lengths to be formed from plastic liner blank 102. As is known, a conventional bag machine makes seal 16 at a predetermined location by typically applying heat and pressure to this predetermined location to form seal 16 in plastic liner blank 102. One conventional sealing device involves the use of a hot knife apparatus which introduces heat and pressure along seal line 16 at the predetermined location thereby forming seal 16 by evenly sealing across the width of folded plastic liner blank 102 shown in FIG. 5. This sealing process is continued at predetermined intervals along the length of plastic seal blank 102 so that a plurality of individual seals 16 are formed in plastic liner blank 102. Each individual seal 16 is formed by bonding all of the folded material comprising plastic liner blank 102 together by application of heat and pressure to form seal 16. Each individual seal 16 is substantially parallel to one another. At the same time that folded plastic liner blank 102 is sealed along seal line 16, perforated separation line 18 is formed adjacent to each seal 16. Both seal 16 and perforated separation line 18 define individual plastic liners 100 and perforated separation lines 18 permit an individual plastic liner 100 to be removed from plastic liner blank 102. This also permits the sealed and perforated plastic liner blank 102 to be used in a dispenser which conveniently stores plastic liner blank 102 and permits an individual plastic liner 100 to be separated therefrom and disposed in the container.

Unlike conventional liners, plastic liner 100 of the present invention is folded along central fold line 118 prior to the sealing of plastic liner 100. Thus, the sealing of plastic liner 100 seals the gusseted regions on top of one another and provides a reinforced seal 16 having a substantially uniform thickness. It has been found that plastic liner 100 of the present invention presents an article designed to catch and hold animal meat in a leak-proof manner so that the meat is easily transportable for further processing and/or packaging. More importantly, the present construction of plastic liner 100 offers a strong, leak-proof bottom seal which does not include an inherently weak bottom seal 16 which is associated with prior art liners for use in the meat packing industry. This is partly because of the folding action along center fold line 118 prior to the sealing of plastic liner 100. More specifically, a better seal 16 is formed in accordance with the present invention because seal 16 is of a substantially uniform thickness throughout the width of plastic liner 100. This results because the central region 116 between gussets 104 is minimal and thus seal 16 comprises an eight folded material seal 16 due to folded gussets 104. Because gussets 104 are folded on one another prior to sealing, seal 16 has a substantially uniform thickness along its length. Because the thickness of seal 16 is uniform, the inherently weak point of the prior art is eliminated. Thus, the present invention eliminates the leakage of blood from the bottom seal and is more cost effective than current practices. The type of seal used as the bottom seal of the present invention is known as a star seal configuration.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for manufacturing a liner for use with a container used in the meat packing industry to hold meat from a carcass, comprising:
providing a sheet of plastic material; and
configuring said sheet of plastic material to hold meat from a carcass, said configuring comprising:
forming a pair of side gussets in said sheet at a first side and an opposing second side of said sheet;
folding said sheet in half so that one of said gussets is disposed on top of the other of said gussets; and
sealing one end of the folded sheet so that said gussets are sealed to one another.

2. The process as set forth in claim 1, wherein said provided plastic sheet comprises polyethylene.

3. The process as set forth in claim 1, wherein said provided sheet is initially in the form of a plastic film tubular member.

4. The process as set forth in claim 1, wherein each of said side gussets includes a first inner surface and an opposing second inner surface, said first inner surface having a first outer edge, said second inner surface having a second outer edge, said first and second inner surfaces converging at an inner edge, wherein when one of said gussets is folded over said other of said gussets, said first outer edge is disposed adjacent and parallel to said second outer edge.

5. The process as set forth in claim 1, wherein said sealing of said first end comprises:
sealing said first end of said folded sheet by applying heat and pressure along a seal line at a predetermined location of said sheet.

6. The process as set forth in claim 1, further comprising:
forming a perforated separation line adjacent said seal.

7. The process as set forth in claim 1, wherein the pair of side gussets are formed so that a distance of about 1-2 inches lies between inner edges of the pair of side gussets.

8. The process as set forth in claim 1, wherein said provided sheet has a length of about 96 inches.

9. The process as set forth in claim 1, wherein said provided sheet has a width of about 88 inches before said gussets are formed and said sheet is folded in half.

10. The process as set forth in claim 1, wherein the material of said provided sheet has a thickness of about 3 mil.

11. The process as set forth in claim 1, wherein the said sheet is folded such that the folded sheet is generally rectangular.

12. The process as set forth in claim 1, wherein said one end of said folded sheet is sealed such that it has a substantially uniform thickness along the seal.

13. The process as set forth in claim 1, wherein said one end of said folded sheet is sealed such that the seal substantially seals eight layers of said plastic material forming said folded sheet member.
